(19) United States
(12) Patent Application Publication
(10) Pub. No.: US 2026/0222314 A1
(43) Pub. Date: Jul. 30, 2026

(54) SYSTEMS AND METHODS FOR RADIO AREA NETWORK FOUNDATIONAL MODEL TUNING USING NETWORK FEEDBACK AND REINFORCEMENT LEARNING

(71) Applicant: Dell Products L.P., Round Rock, TX (US)

(72) Inventors: Gwenael Poitau, Montreal (CA); Ibrahim Abu Alhaol, Nepean (CA); Javad Mirzaei, Toronto (CA); Rohit Arora, San Jose, CA (US); Said Tabet, Austin, TX (US)

(21) Appl. No.: 19/039,325

(22) Filed: Jan. 28, 2025

(51) Int. Cl. H04L 41/16; G06N 3/092; H04W 24/02

(52) U.S. Cl. CPC H04L 41/16; G06N 3/092; H04W 24/02

(57) ABSTRACT

Foundational model tuning for network management and application is disclosed. Network feedback is generated by a physical network (RAN), a network model included in a digital twin or is received from other sources, including a network operator, and stored in a database. The network feedback stored in the database, along with graph data from a knowledge graph of the network, is used to generate a prompt and train a model copy using reinforcement learning. Updates derived or obtained from the model copy are incorporated into the network model. This allows the network model to be tuned to the network and network management and monitoring operations.

### TECHNOLOGICAL FIELD OF THE DISCLOSURE

Embodiments disclosed herein generally relate to network management operations and network monitoring operations. More particularly, at least some embodiments relate to systems, hardware, software, computer-readable media, and methods for tuning models used in network management and monitoring operations using network feedback and reinforcement learning.

### BACKGROUND

Networks, such as radio access networks (RANs) and telecommunication networks, are often heterogenous in nature. For this and other reasons, real-time network management and monitoring are critical operations. One aspect of network management and monitoring is risk assessment. For example, an event such as performing a network update is associated with a risk that something may go wrong. For example, updating the network may cause a network outage or a performance degradation.

Assessing risk associated network managing and monitoring operations, however, is difficult and a network operator is often unsure of the actual risk for various reasons. For example, a network operator may be unaware of all inter-dependencies and inter-relationships that may exist among the components of the network. This lack of understanding prevents the operator from fully appreciating the risk and limits the ability of the operator to accurately assess the risk. In another example, conventional models used in performing various network related operations are often trained on generic sets of public data, which may be unrelated to real-time network management and monitoring operations. This may result in inefficient solutions to network issues, poor risk assessments, and/or model hallucinations.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1A discloses aspects of a network that may include a radio access network or an open radio access network;

FIG. 1B discloses aspects of a system configured to tune a model based on network feedback and reinforcement learning;

FIG. 1C discloses aspects of a knowledge graph of a network;

FIG. 2 discloses aspects of a system configured to tune a model based on network feedback from a digital twin and reinforcement learning;

FIG. 3 discloses aspects of a system configured to tune a model based on network feedback from a user and reinforcement learning;

FIG. 4 discloses aspects of a system configured to tune a model based on network feedback from multiple sources;

FIG. 5 discloses aspects of a method for tuning a model used in or by network applications; and

FIG. 6 discloses aspects of a computing device, a computing system, or a computing entity.

### DETAILED DESCRIPTION OF SOME EXAMPLE EMBODIMENTS

Embodiments disclosed herein generally relate to tuning models for network operations including network management, network monitoring, and network control. More particularly, at least some embodiments relate to systems, hardware, software, computer-readable media, and methods for tuning models using network feedback and reinforcement learning.

Embodiments of the invention are discussed in the context of networks such as radio access networks (RANs) or open radio access networks (O-RAN). Embodiments of the invention, however, may be implemented in other networks including telecommunication networks, wireless networks, heterogeneous networks, or the like or combinations thereof. Embodiments of the invention are further discussed in the context network management and monitoring operations such as risk assessment and what-if scenarios, but may be used in other contexts including network troubleshooting, issue identification, solution recommendation, performance improvement, network updates/upgrades, or the like or combinations thereof.

In management and monitoring operations, network operators benefit from knowing the risk associated with various events. For example, the ability to assess the impact of a network upgrade or update before the upgrade or update is applied may determine whether the upgrade or update is actually applied, discarded, or delayed for further network preparation.

Risk assessment and what-if scenarios are often performed using a digital twin. A digital twin may include a model (e.g., an agentic foundation model (AFM), a large model (LM), a large language model (LLM)) that is trained on historical network data associated with a network state to generate or identify a network state. When the digital twin is presented with a scenario, the digital twin may employ the model to determine or estimate the network state if the scenario occurs or is performed. More specifically, the digital twin may employ the model to determine or estimate the outcome and impact of such a scenario if implemented in the network. Based on the output of the digital twin, the scenario may be allowed or implemented in the network. An example scenario may include an update to certain network components. The digital twin may be able to generate a network state representing the impact of the update on the operations and functions of the network. The operator, based on the network state generated by the digital twin, may perform the update, delay the update, or discard the update.

One challenge facing digital twins is that the models included in or relied on by the digital twins that has not been fined tuned for the relevant network. Embodiments of the invention relate to a feedback engine that is configured to update the model based on network feedback and reinforcement learning. This allows the models to be fine-tuned to the specific network. This also allows the model to be adapted to changes in the network (e.g., network growth, reconfigurations).

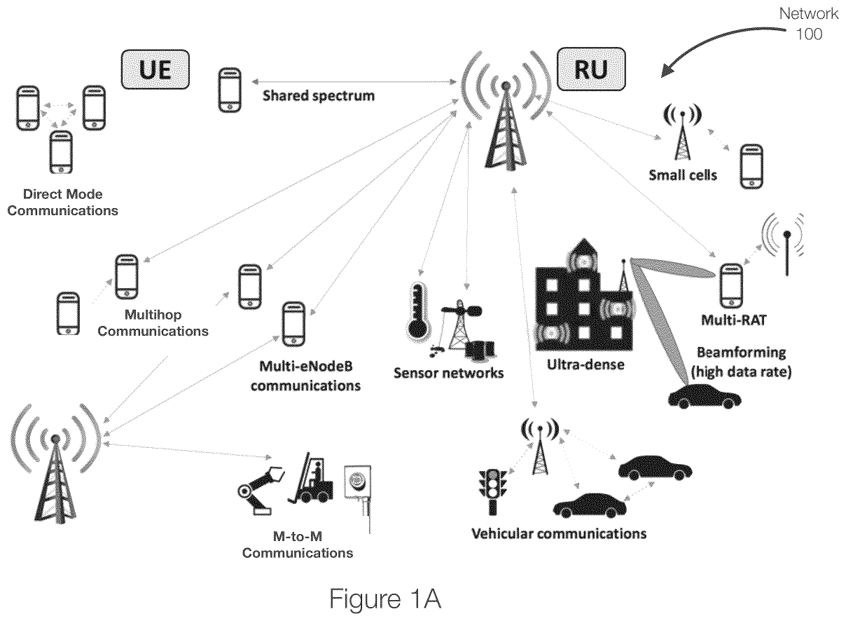

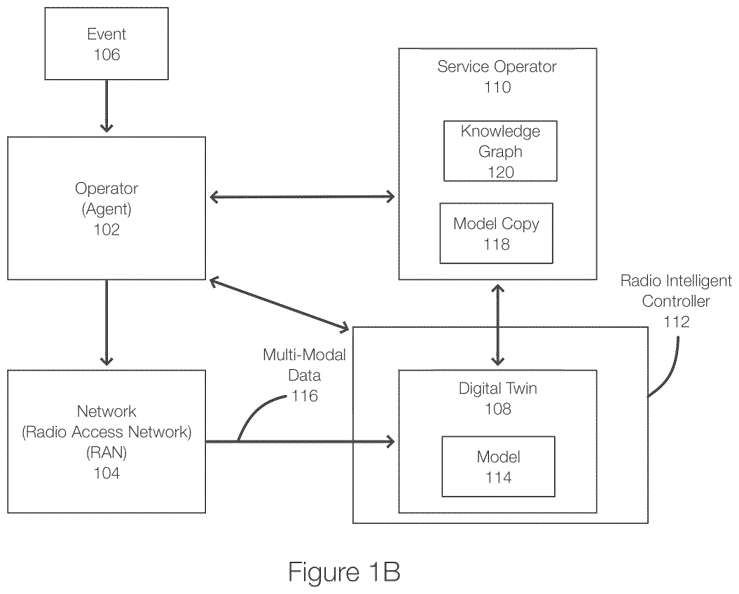

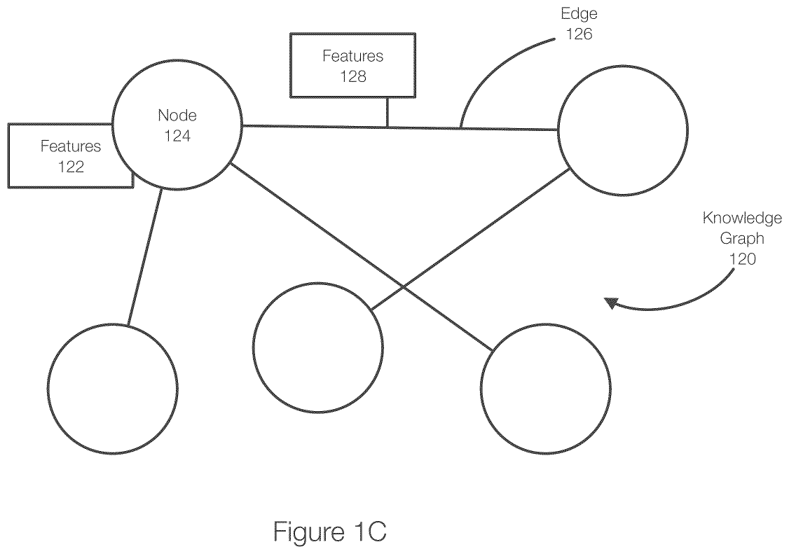

FIG. 1A discloses aspects of an example network. FIG. 1A illustrates a network 100, which is an example of or which includes an example of or instances of an O-RAN or RAN. In this example, the network 102 includes towers, small cells, user equipment, multihop communications, multi-enodeB communications, sensor networks, vehicular communications, M-to-M communications, ultra-dense networks multi-RAT, beamforming, and the like. These components may represent or include radio units (RU), distributed units (DU), and/or centralized units (CU).

FIG. 1B discloses aspects of tuning a model, for use by network applications, using network feedback and reinforcement learning. FIG. 1B illustrates a system that includes a network (e.g., a RAN or O-RAN) 104 and a radio intelligent controller (RIC) 112 associated with the network 104. In this example, the network 104 is an example of the network 102 or portion thereof and the RIC 112 includes or has access to a digital twin 108. The digital twin 108 includes a model 114, such as an AFM or an LLM.

The model 114 may be (at least initially), for example, an off-the-shelf model that has not been tuned for the network 104. In other words, even if the model 114 is configured to generate network states when initially deployed, the model 114 may not be tuned to predict or infer states specific to the network 104.

Embodiments of the invention may incorporate feedback from the network 104, the digital twin 108, and/or the operator 102 to train the model 114 in a service operator 110. More specifically, the service operator 110 may use the network feedback, along with a database of historical data (e.g., historical feedback), to perform reinforcement learning to train the model copy 118. In this example, the model copy 118 is a copy of the model 114. As the model copy 118 is trained in the service operator 110, model updates are generated from the model copy 118 and incorporated into the model 114. This allows the model 114 to be tuned to the network 104 and improves the predictions and outputs of the model 114 and of the digital twin 108.

For example, an operator (which may be an AI agent) 102 may receive or identify an event 106. The event 106 is representative of circumstances, updates, upgrades, or other things that may impact the operations and functions of the network 104. The event 106 also represents events that occur in the network (e.g., updates) and events that occur to the network (e.g., weather, concerts).

In this example, the digital twin 108 may be employed to assess or determine a risk associated with the event. The operator 102, based on the output of the digital twin 108, may or may not proceed with the event (e.g., if the event an upgrade or update). If the event 106 is an anticipated external condition (e.g., weather, large crowd), the digital twin 108 may generate a recommended protective action (e.g., increase power of base station, allocate more resources) or the recommended protective action may be generated based on the predicted state of the network. If the event 106 is degraded performance, an outage, or the like, the digital twin 108 may generate a potential solution and/or a predicted network state if the potential solution is implemented.

In the case of an event such as a what-if scenario (e.g., a planned update), the digital twin 108 may provide an assessment and impact if the update is applied. A risk score may be associated with the event. The event, the anticipated state, and the score may also be provided to the service operator 110 and stored in a database. More specifically, the service operator 110 may include or be associated with a database of tuples (e.g., (event, state, score)) and use the database in conjunction with a knowledge graph 120 to perform reinforcement learning to train the model copy 118. Updates from the trained model copy 118, as previously states, are applied to the model 114.

In this example, the model 114 generates an output (e.g., a predicted network state) based on multi-modal data 116, which represents a current or most-recent state of the network 104. The multi-modal data 116 may include, but is not limited to, measurements or representations of radio frequency (RF) signals and other key performance indicators (KPIs). KPIs can be categorized into various types including network KPIs (e.g., latency, throughput, connection density), quality of service KPIs (e.g., handover success rate, jitter, network availability), operational KPIs (e.g., resource efficiency/usage, interoperability, fault recovery), AI/ML (artificial intelligence/machine learning) metrics (e.g., accuracy, inference time). These KPIs may include other key performance indicators such as time stamps, velocity (e.g., user equipment speed, direction), signal strengths, latency, throughput, and the like.

The multi-modal data 216 may also include, in addition to KPI data, camera data (RGB data, depth data), LiDAR (Light Distance and Ranging) data, RF (Radio Frequency) data, position (e.g., GPS or global positioning system) data, sensor data, or the like or combinations thereof. In one example, the model copy 118 is trained based on historical multi-modal data, scenarios, risk scores, and the like. As a result, the model 114, which is updated based on the training of the model copy 118, generates predictions in a manner that accounts for inter-dependencies of network components and elements.

A knowledge graph 120 of the network 104 may also be available to and/or included in the service operator 110 and/or the digital twin 108. FIG. 1C discloses aspects of a knowledge graph that may represent a network such as a RAN or O-RAN. FIG. 1C illustrates a knowledge graph 120 that represents at least a portion of the network 104 in FIG. 1B. In this example, the knowledge graph 120 includes nodes, represented by the node 124, and edges, represented by the edge 126. The node 124 is associated with features 122 and the edge 126 is associated with features 128.

The knowledge graph 120 represents a network of real-world components, including, but not limited to, objects, events, situations, concepts, or the like. In the context of an O-RAN, nodes represent the real-world components of the O-RAN. Thus, the knowledge graph 120 may include nodes for each radio unit (RU), each distributed unit (DU) and each central unit (CU). Other components and elements of the network may be represented in the knowledge graph 120. For example, the node 124 may represent a base station. If the node 124 represents a base station, the features 122 may include, by way of example only, location (e.g., GPS (Global Positioning System) coordinates), supported frequency bands, maximum number of supported UEs (or traffic capacity), maximum transmission power, antenna configuration, and the like or combinations thereof.

In another example, if the node 124 represents a cell, the features 122 may include a cell identifier, an area served by the cell, scheduling information, or the like or combinations thereof. The features of any particular node include the features or characteristics of the corresponding network element or component.

The edge 126 may represent relationships between two or more nodes (e.g., two RUs that are communicating). The edge 126 may represent, by way of example only, a connection or a relationship between a base station and a cell, a cell and user equipment, a base station and an antenna, a cell and a core network, or the like. The features 128 of the edge 126 may depend on the connection or relationship. For example, the features 128 of an edge 126 that represents a connection or relationship between a cell and a UE may include signal strength, allocated resources, handover data, and the like.

The features 122 and 128 may also include operating characteristics (e.g., stable or constant values such as maximum power, maximum number of connections, software version) and/or measurements or other values that may reflect a current state the network component. For example, the features of a base station may include a total resources feature (fixed or constant) and a resources available feature (variable, depends on usage or load). Thus, resources available feature may vary depending on usage. Similarly, the transmission power of a radio may include maximum power feature and a current transmission power feature. The knowledge graph 120 stores knowledge that can be queried, retrieved, and the like. The knowledge graph 120 can also be used for information retrieval, recommendations, and the like.

Stated generally, the knowledge graph 120 is constructed from features of the network (e.g., the RAN or O-RAN illustrated by or included in the network 102) and include, by way of example, position data, quality of service (QoS) measurements, radio frequency (RF) measurements, and the like. Embodiments of the invention further include environmental semantic information, which may include contextual data, such as environmental data, image data, or the like, which may be incorporated into the graph 120. The graph 120 may also include or account for standards, network logs, and the like. The model copy 118 may also be trained using standards, network logs, and the like. Stated differently, the model copy 118 is trained, in one example, using network feedback that complies with standard guidelines, acceptable operating parameters, and the like, such that the updates derived or obtained from the model copy 118 incorporated into the model 114 reflect acceptable network operations.

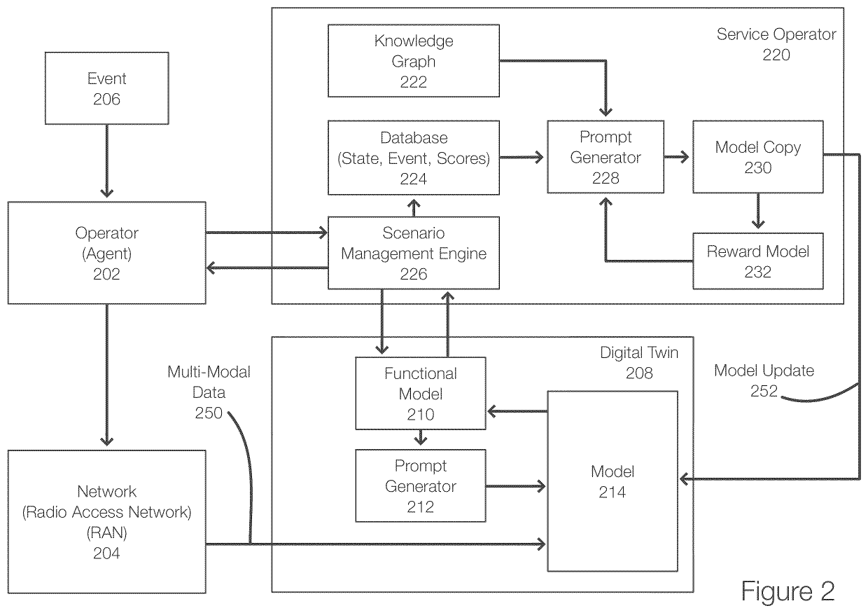

FIG. 2 discloses aspects of a system configured to tune a model (e.g., a network model used in the context of performing network related operations) based on network feedback from a digital twin and reinforcement learning in a model copy. FIG. 2 illustrates a system that includes an operator 202 associated with a network 204 (e.g., a RAN or O-RAN). The network 204 may be associated with a radio intelligent controller (RIC), which may include a digital twin 208.

The digital twin 208 includes a model 214 that may be configured to predict or estimate a network state based on a prompt. More specifically, the model 214 (e.g., an AFM or LLM) may, at least initially, an off-the-shelf model trained on generic data. In one example, the model 214 may be trained on generic network data and be capable of generating network states. When presented with a what-if scenario (e.g., a system update, the addition of a base station), the model 214 may predict the resulting network state. The output of the digital twin 208 (or more specifically the model 214) in response to an event 206 may determine whether the event 206 is allowed to proceed, delayed, or cancelled. If the event 206 is already occurring in the network, the model 214 may also be configured to predict or provide a recommended solution. More generally, the model 214 is configured to enable operations performed in a digital twin.

In one example, the operator 202 may become aware of an event 206. This example assumes that the event 206 is a planned event such as a network upgrade or update. The operator 202 may submit the event 206 to a scenario management engine 226 of a service operator 220. The scenario management engine 226 submits the event 206 to a functional model 210. The functional model 210 may generate a prompt or cause a prompt generator 212 to generate a prompt to the model 214. In effect, the functional model 210 generates a what-if prompt that is input to the model 214 such that the impact of the event 206 can be estimated or predicted by the model 214. The model 214 may also receive the multi-modal data 250 from the network 204, which reflects the current network state and which reflects inter-dependencies of network components, and may have access to the knowledge graph 222.

The model 214 may generate a response that is directed to the scenario management engine 226 (via the functional model 210 in one example). In one example the functional model 210 may map the response of the model 214 to a risk score. The functional model 210 may be trained on data of historical events and their impact on network state, operations and/or functions.

The response and/or risk score is then returned to the operator 202 and the operator 202 makes a decision regarding the event 206 based on the output of the model 214 and/or the risk score determined by the functional model 210. A risk score may reflect a likelihood that the network performance may be adversely impacted by the event 206. For example, if the model 214 predicts that the network will experience a performance decrease (e.g., the predicted network state reduces resource availability), the risk score generated by the functional model may reflect this possibility. The risk score may also depend on a target use case and the KPI of interest. For example, if certain update is scheduled, (new cell configuration for example), the KPIs of interest may include user call drop rate or power consumption increase. In this example, the model may generate risk scores against these metrics. The prediction or risk score may allow the operator to make a decision. For example, the risk score may indicate that a 10% power consumption increase, which may be greater than a threshold level. The risk score may change based on the scope of the potential increase in this example.

Embodiments of the invention relate to tuning the model 214 and this is achieved by the service operator 220. In this example, a database 224 of tuples (e.g., (network state, event, scores) is included in the service operator 220. Thus, when the event 206 is processed by the digital twin 208 and a response is returned to the operator 202, the event, the network state, and the risk score may also be stored in the database 224. The database 224 may also store a tuple reflecting the actual network state after the event 206. The database 224 thus includes a history of events, their associated network states (e.g., prior/post event network states), and associated risk scores.

Reinforcement learning is performed by the service operator 220. A prompt generator 228 receives or obtains data from the database 224 and data from the knowledge graph 222 as input to a prompt generator 228. A prompt is generated and reinforcement learning is performed using the model copy 230 and a reward model 232. The service operator 220 thus receives network feedback (e.g., predicted state, resulting network state, event, and/or risk scores of an event), and uses the network feedback to perform reinforcement learning using a model copy 230.

As the model copy 230 is trained in this manner, a model update 252 may be generated and incorporated into the model 214 of the digital twin 208. The service operator 220, using network feedback and reinforcement learning, is configured to fine tune the model 214 by training the model copy 230, which is a copy of the model 214.

The model 214 is able to provide a comprehensive view of inter-dependencies among the network components in real-time or near-real time, which allows events 206 to be assessed more accurately. The model 214 is further tuned according to real-time network feedback that complies, in one embodiment, with standard guidelines. By incorporating the network feedback into the model 214, the model 214 is tuned to produce more effective and trustworthy risk scores for network applications related to the network 204. Further, the model 214 can be continuously or repeatedly tuned and updated by the service operator 220. Thus, changes to the network (e.g., network scaling, component addition/removal, upgrades, network reconfigurations) will be reflected in the learning of the model copy 230 and incorporated into the model 214 via model updates.

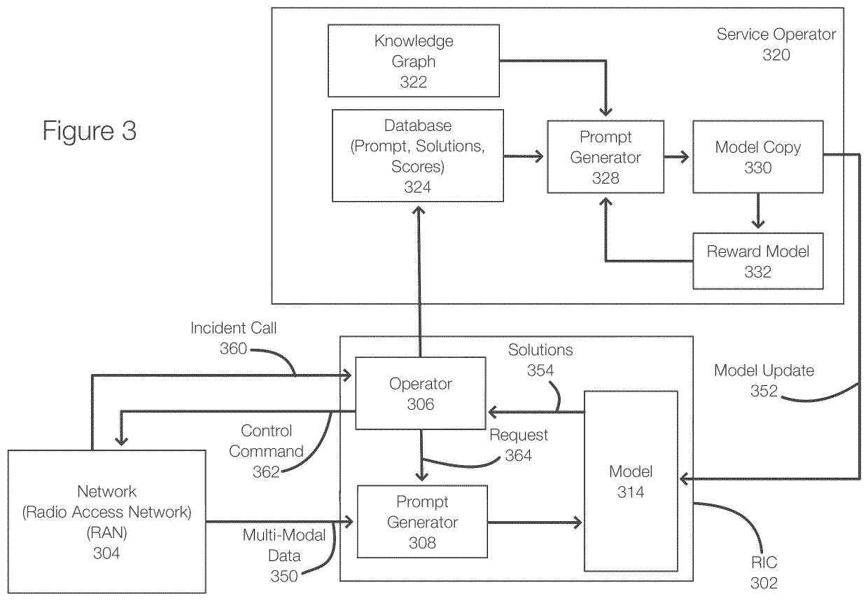

FIG. 3 discloses aspects of a system configured to tune a model based on network feedback from a user. In this example, a network 304 is associated with a RIC 302 that includes a model 314 and a prompt generator 308. The prompt generator 308 is configured to generate a prompt to the model 314 based on multi-modal data 350 and a request 364 from an operator 306.

More specifically, the operator 306 may receive an incident call 360 from the network. The incident call 360 may be related an event such as an upgrade or an event such as an incident (e.g., a detected outage, a detected performance degradation). The operator 306 generates the request 364 based on the incident call 360 and the prompt generator 308 generates a prompt to the model 314 based on the request 364 and the multi-modal data 350. In some examples, the prompt generator 308 may also have access to the knowledge graph 322 of the network 304.

The model may be configured to generate one or more recommended solutions 354 to the incident call 360. The operator 306 may evaluate the solutions 354 and generate a control command 362 implementing the selected solution. The operator 306 may also reject the solutions 354, delay the solutions 354, or the like.

In this example, the operator 306 may also input this type of network feedback into the database 324 maintained or accessible to the service operator 320. In this example, the tuple may be (prompt, solutions, risk scores). Thus, the database 324 may include data that reflects network feedback from the operator 306.

The service operator 320 may perform reinforcement learning to a model copy 330, which is a copy of the model 330. In this example, the prompt generator 328 may use or access the database 324 and the knowledge graph 322 to generate a prompt to the model copy 330. The reward model 332 can be used to generate a reward that may be added to the prompt generator 328. Thus, reinforcement learning is performed to tune the model copy 330 at the service operator 320. In one example, the reward model 332 may be trained based on ranked solutions, risk scores, or the like.

The service operator 320 can then generate or produce a model update 352, which is incorporated into the model 314 of the RIC 302. This allows the model 314 to be tuned by the service operator 320, which implements reinforcement learning based on user feedback to tune the model copy 330.

In the example of FIG. 3, the model 314 is tuned, via the model updates generated by the service operator 320, to the preferences of the operator 306 (e.g., a domain expert) and real-time network feedback that complies, in one example, with standard guidelines. This tunes the model 314 to generate for effective, safe, and trustworthy solutions or scores and allows the model 314 to be tuned and updated continuously or repeatedly.

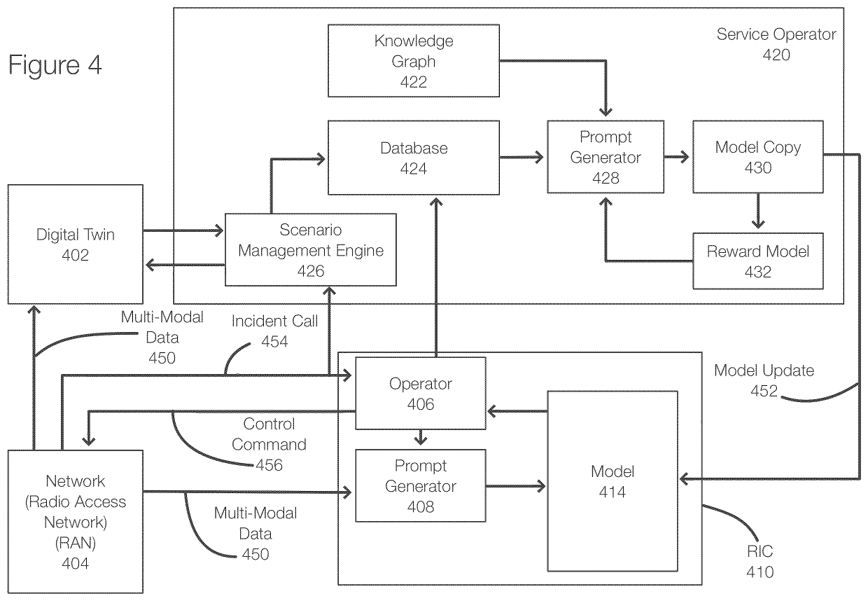

FIG. 4 discloses aspects of a system configured to tune a model based on multiple feedback sources. FIG. 4 illustrates a system that includes a network 404, a digital twin 402, an RIC 410, and a service operator 420. In this example, the digital twin 402 may include a model or may use the model 414 to perform functions such as what-if scenarios based in part on the multi-modal data 450 from the network 404 and/or a network state and/or risk score generated by a model. Thus, the digital twin 402 may provide network feedback (network state, scenario, solutions) to the scenario management engine 426 based on these inputs and add data to the database 424. Thus, the service operator 420 may receive network feedback from a digital twin 402.

Similarly, the operator 406 may receive an incident call 454. The incident call 454 may also be added to the scenario management engine 426 (and a what-if scenario may be executed by the digital twin 402). This allows network feedback related to the incident call 454 to be included in the database 424 from the perspective of the digital twin 402 and/or the operator 406.

The prompt generator 408 may generate a prompt to the model 414 based on the incident call 454 (or corresponding request generated by the operator 406 in response to the incident call 454) and the multi-modal data 450. The solutions recommended by the model 414 in response to the incident call 454 are provided to the operator 406 and the operator 406 may add data representing network feedback to the database 424. This database 424 may store network data in the form of tuples such as (prompt, state, solutions, scores) or the like. The format of the tuples may be normalized and may account for the source of the network feedback.

The service operator 420 is thus configured to perform reinforcement learning using the database 424 and the knowledge graph 422. In this manner, the model copy 430 is trained using a reward model 432 via reinforcement learning in one example.

The model copy 430 is used to generate a model update 452 that is incorporated into the model 414 (and/or the model of the digital twin 402). FIG. 4 illustrates that models for networking applications can be tuned from network feedback received from a network operator, a digital twin of the network, and/or the physical network (e.g., after control command implementation). Aspects of FIGS. 2-4 may be incorporated into each other.

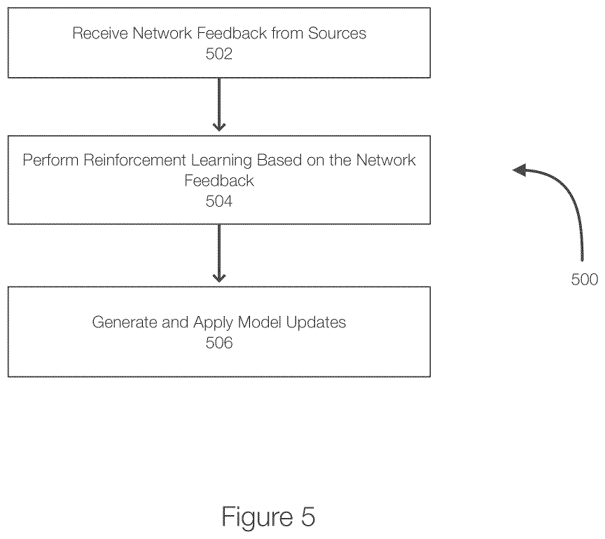

FIG. 5 discloses aspects of a method for tuning a model for network applications. The method 500 includes receiving 502 network feedback from one or more sources. For example, the network feedback may include a risk score and/or a network state generated by a model included in or accessible to a digital twin. The network feedback received from the digital twin is incorporated into a database. The database may store network feedback related to what-if scenarios or other applications such as (state, scenario, scores).

The network feedback may also include network feedback from an operator or agent. In this example, the network feedback may be related to incidents and to solutions to the incidents recommended by a model and presented to the operator. This network feedback, which may be stored in the database, may include network feedback such as (prompt, solutions, scores). Thus, the prompt generated for the model in response to the incident call, the recommended solutions, and the associated scores (e.g., risk scores) may be stored in the database. The network feedback may also include network states after implementing a command (e.g., in response to an incident, an event, a scenario) in the network.

Next, reinforcement learning is performed 504 based on the network feedback stored in the database. Reinforcement learning may be augmented with a knowledge graph of the network. The reinforcement learning is performed on a model copy of the model used in the network or digital twin. Embodiments of the invention can expand to account for multiple network model. In other words, multiple model copies may be trained using reinforcement learning.

Periodically or at other times, updates are generated from the model copy trained using network feedback and reinforcement learning and the model updates generated from the model copy are applied 506 to the network model in the RIC or digital twin.

Advantageously, incorporating network feedback into network models using network feedback from one or more sources allows the network models to be tuned and produce more effective and trustworthy outputs for network applications related to the network. Further, the network models can be continuously or repeatedly tuned and updated by the service operator.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, multi-modal data related operations, knowledge graph operations, training operations, reinforcement learning operations, network feedback operations, model tuning operations based on network feedback from one or more sources and reinforcement learning, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Further, the AFMs, GNNs, LLMs, and other models may be trained with historical and/or synthetic data.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.
Embodiment 1. A method comprising: receiving network feedback related to a network at a service operator, generating a prompt based on the network feedback stored in a database of the service operator and a knowledge graph of the network, performing reinforcement learning to train a model copy of a network model associated with the network based on the prompt, generating updates from the model copy that has been trained with the reinforcement learning, and applying the updates to the network model to tune the network model to operations and functions of the network.
Embodiment 2. The method of embodiment 1, wherein the network feedback includes first network feedback generated by a digital twin that includes the network model, wherein the first network feedback is generated in response to at least a what-if scenario received at the digital twin from an operator.
Embodiment 3. The method of embodiment 1 and/or 2, wherein a functional model receives the what-if scenario and causes a prompt generator to generate a scenario prompt to the network model, wherein the network model generates a network state based on the scenario prompt and multi-modal data received from the network, wherein the functional model is configured to map the network state generated by the network model to a risk score.
Embodiment 4. The method of embodiment 1, 2, and/or 3, further comprising storing, in the database of the service operator, the first network feedback, wherein the first network feedback includes at least a network state, the scenario, and the risk score.
Embodiment 5. The method of embodiment 1, 2, 3, and/or 4, wherein the reinforcement learning performed to train the model copy is based on prompts generated from the network feedback, including the first network feedback, stored in the database and graph data retrieved from a knowledge graph of the network.
Embodiment 6. The method of embodiment 1, 2, 3, 4, and/or 5, wherein the network feedback includes second feedback received from an operator.
Embodiment 7. The method of embodiment 1, 2, 3, 4, 5, and/or 6, wherein a request is generated in response to an incident call and a prompt to the network model is generated from the request and multi-modal data received from the network, wherein the second network feedback is based on evaluation of recommended solutions to the incident call generated by the network model.
Embodiment 8. The method of embodiment 1, 2, 3, 4, 5, 6, and/or 7, wherein the second network feedback includes the prompt to the network model, the recommended solutions, and risk scores of the recommended solutions and wherein the second network feedback is included in the network feedback stored in the database.
Embodiment 9. The method of embodiment 1, 2, 3, 4, 5, 6, 7, and/or 8, further comprising receiving third network feedback from the network wherein the third network feedback includes a network state of the network after implementing a control command, wherein the third network feedback is incorporated into the network feedback stored in the database.
Embodiment 10. The method of embodiment 1, 2, 3, 4, 5, 6, 7, 8, and/or 9, wherein the network comprises an open radio access network, the network model comprises an agentic foundation model or a large language model, and the updates obtained from the model copy are configured to tune the network model for the network.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

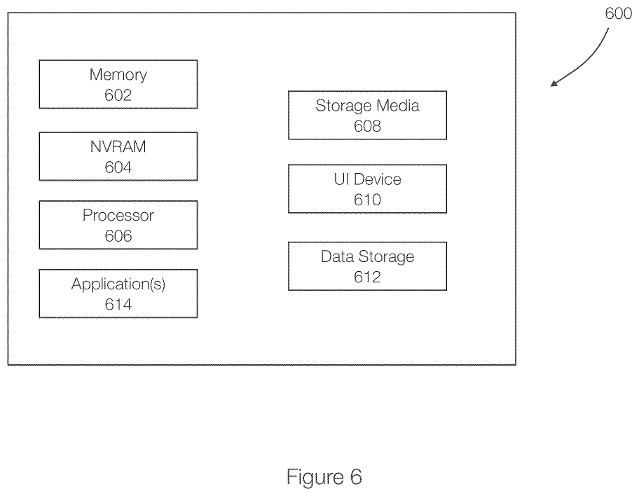

With reference briefly now to FIG. 6, any one or more of the entities disclosed, or implied, by the Figures and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

The device 600 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 600 may also represent a physical or virtual machine or server, an edge-based computing system, a cloud-based computing system, server clusters or other computing systems or environments. The device 600 may also represent multiple machines or devices, whether virtual, containerized, or physical. The device 600 may perform or execute steps or acts of the methods illustrated in the Figures.

The device 600 may represent a cloud-based system, an edge-based, system, an on-premise system, or combinations thereof. The device 600 may be a computing system that is distributed geographically. For example, a network digital twin may include twin components implemented in a plurality of distributed devices 600.

In one example, the RIC and/or digital twin may be integrated with the network, may be implemented using servers, clusters, or the like. The RIC and/or digital twin may include distributed components or elements.

The described embodiments are to be considered in all respects only as illustrative and not restrictive. All changes which come within the meaning and range of equivalency of the claims are to be embraced within their scope.

What is claimed is:

1. A method comprising:
receiving network feedback related to a network at a service operator;
generating a prompt based on the network feedback stored in a database of the service operator and a knowledge graph of the network;
performing reinforcement learning to train a model copy of a network model associated with the network based on the prompt;
generating updates from the model copy that has been trained with the reinforcement learning; and
applying the updates to the network model to tune the network model to operations and functions of the network.

2. The method of claim 1, wherein the network feedback includes first network feedback generated by a digital twin that includes the network model, wherein the first network feedback is generated in response to at least a what-if scenario received at the digital twin from an operator.

3. The method of claim 2, wherein a functional model receives the what-if scenario and causes a prompt generator to generate a scenario prompt to the network model, wherein the network model generates a network state based on the scenario prompt and multi-modal data received from the network, wherein the functional model is configured to map the network state generated by the network model to a risk score.

4. The method of claim 3, further comprising storing, in the database of the service operator, the first network feedback, wherein the first network feedback includes at least a network state, the scenario, and the risk score.

5. The method of claim 4, wherein the reinforcement learning performed to train the model copy is based on prompts generated from the network feedback, including the first network feedback, stored in the database and graph data retrieved from a knowledge graph of the network.

6. The method of claim 1, wherein the network feedback includes second feedback received from an operator.

7. The method of claim 6, wherein a request is generated in response to an incident call and a prompt to the network model is generated from the request and multi-modal data received from the network, wherein the second network feedback is based on evaluation of recommended solutions to the incident call generated by the network model.

8. The method of claim 7, wherein the second network feedback includes the prompt to the network model, the recommended solutions, and risk scores of the recommended solutions and wherein the second network feedback is included in the network feedback stored in the database.

9. The method of claim 1, further comprising receiving third network feedback from the network wherein the third network feedback includes a network state of the network after implementing a control command, wherein the third network feedback is incorporated into the network feedback stored in the database.

10. The method of claim 1, wherein the network comprises an open radio access network, the network model comprises an agentic foundation model or a large language model, and the updates obtained from the model copy are configured to tune the network model for the network.

11. A non-transitory storage medium having stored therein instructions that are executable by one or more hardware processors to perform operations comprising:
receiving network feedback related to a network at a service operator;
generating a prompt based on the network feedback stored in a database of the service operator and a knowledge graph of the network;
performing reinforcement learning to train a model copy of a network model associated with the network based on the prompt;
generating updates from the model copy that has been trained with the reinforcement learning; and
applying the updates to the network model to tune the network model to operations and functions of the network.

12. The non-transitory storage medium of claim 11, wherein the network feedback includes first network feedback generated by a digital twin that includes the network model, wherein the first network feedback is generated in response to at least a what-if scenario received at the digital twin from an operator.

13. The non-transitory storage medium of claim 12, wherein a functional model receives the what-if scenario and causes a prompt generator to generate a scenario prompt to the network model, wherein the network model generates a network state based on the scenario prompt and multi-modal data received from the network, wherein the functional model is configured to map the network state generated by the network model to a risk score.

14. The non-transitory storage medium of claim 13, further comprising storing, in the database of the service operator, the first network feedback, wherein the first network feedback includes at least a network state, the scenario, and the risk score.

15. The non-transitory storage medium of claim 14, wherein the reinforcement learning performed to train the model copy is based on prompts generated from the network feedback, including the first network feedback, stored in the database and graph data retrieved from a knowledge graph of the network.

16. The non-transitory storage medium of claim 11, wherein the network feedback includes second feedback received from an operator.

17. The non-transitory storage medium of claim 16, wherein a request is generated in response to an incident call and a prompt to the network model is generated from the request and multi-modal data received from the network, wherein the second network feedback is based on evaluation of recommended solutions to the incident call generated by the network model.

18. The non-transitory storage medium of claim 17, wherein the second network feedback includes the prompt to the network model, the recommended solutions, and risk scores of the recommended solutions and wherein the second network feedback is included in the network feedback stored in the database.

19. The non-transitory storage medium of claim 11, further comprising receiving third network feedback from the network wherein the third network feedback includes a network state of the network after implementing a control command, wherein the third network feedback is incorporated into the network feedback stored in the database.

20. The non-transitory storage medium of claim 11, wherein the network comprises an open radio access network, the network model comprises an agentic foundation model or a large language model, and the updates obtained from the model copy are configured to tune the network model for the network.
